(19) United States
(12) Patent Application Publication
(10) Pub. No.: US 2007/0057906 A1
(43) Pub. Date: Mar. 15, 2007

(54) Bi-stable display with reduced memory requirement

(75) Inventors: Mark T. Johnson, Veldhoven (NL); Guofu Zhou, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,466

(22) PCT Filed: Sep. 17, 2004
(86) PCT No.: PCT/IB04/51788

§ 371 Date: Mar. 20, 2006

Related U.S. Application Data
(60) Provisional application No. 60/505,002, filed on Sep. 22, 2003.

(51) Int. Cl. G09G 3/34

(52) U.S. Cl. 345/107

(57) ABSTRACT

A display device (401) has groups of display elements (118), which are changed from one optical state to another by applying a waveform (330, 331) sequence of potential differences. The waveforms (330, 331) to be applied are stored in a look-up table (445) in a memory of the device (401). The look-up table is ordered so that portions of the waveforms (330, 331) are reused for different groups of display elements (401). The memory requirement for storing the waveforms (330, 331) is reduced.

The invention relates to a bi-stable display in which display elements are changed from a first to a second display state by application of a potential difference and to an apparatus and method for storing and preparing image data for transmission and transferring image data to the display.

Display devices of this type are typically electrophoretic displays used, for example, in monitors, laptop computers, personal digital assistants (PDA's), mobile telephones and electronic books, newspapers, magazines, etc.

An electrophoretic display comprises an electrophoretic medium (electronic ink or “E-ink”) containing charged particles in a fluid, a plurality of display elements (pixels) arranged in a matrix, first and second electrodes associated with each pixel, and a voltage driver for applying a potential difference to the electrodes of each pixel to cause charged particles to occupy a position between the electrodes, depending on the value and duration of the applied potential difference, so as to display an image or other information.

A display device of the type mentioned in the opening paragraph is, for example, known from international patent application WO 99/53373WO, published Apr. 9, 1999, by E Ink Corporation, Cambridge, Mass., U.S., and entitled “Full Color Reflective Display With Multichromatic Sub-Pixels”. That patent application discloses a display comprising two substrates, one of which is transparent. The other substrate is provided with electrodes arranged in rows and columns. A crossing between a row and a column electrode is associated with a display element or pixel. The display element is coupled to the column electrode via a thin-film transistor (TFT), the gate of which is coupled to the row electrode. This arrangement of display elements, TFT transistors and row and column electrodes jointly forms an active matrix. Furthermore, the display element comprises a pixel electrode. A row driver selects a row of display elements and the column driver supplies a data signal to the selected row of display elements via the column electrodes and the TFT transistors. The data signal corresponds to graphic data to be displayed.

Furthermore, electrophoretic medium is provided between the pixel electrode and a common electrode provided on the transparent substrate. The electrophoretic medium comprises multiple microcapsules of about 10 to 50 microns. Each microcapsule comprises, for example, positively charged white particles and negatively charged black particles suspended in a fluid. When a negative field is applied to the common electrode, the white particles move to the side of the microcapsule directed to the transparent substrate, and the display element becomes visible to a viewer. Simultaneously, the black particles move to the pixel electrode at the opposite side of the microcapsule where they are hidden from the viewer. By applying a negative field to the pixel electrode, the black particles move to the common electrode at the side of the microcapsule directed to the transparent substrate, and the display element appears dark to a viewer. When the electric field is removed, the display device remains in the acquired state and exhibits a bi-stable character.

Grayscale or gradients in color in the display device images can be generated by controlling the amount of particles that move to the counter electrode at the top of the microcapsules. For example, the energy of the positive or negative electric field, defined as the product of field strength and time of application, controls the amount of particles moving to the top of the microcapsules. These gradations are, generally, created by applying voltage pulses for specified time periods.

These displays are strongly influenced by image history, dwell time, temperature, humidity, lateral inhomogeneity of the electrophoretic foils, etc. In particular, to offset these and other factors and bring a display element to a desired optical state, there is often a need to apply a sequence of potential differences, rather than a single potential difference. The potential difference or sequence of potential differences is also referred to in this application as a waveform. Reference waveforms for various transitions between optical states are typically stored in the form of look-up tables in the display device memory. Waveforms are typically composed of multiple frames because display requires a longer address time than the holding ratio of the active display.

With regard to image history, a problem with electronic ink displays is a severe image retention problem because of the strong memory effect (bi-stability) and dwell time effect. To reduce the effect of dwell time and image history, it has been proposed to use a series of short ac voltage pulses prior to the driving voltage pulse, as disclosed in prior, non-pre-published co-pending application EP 02077017.8, filed May 24, 2002 (Applicants'number PHNL020441). In order to completely erase the previous image, a longer pulse-time period is preferably required. The image update visibility, however, increases with increasing the pulse time period. This phenomenon is known as jitter or flicker in LCDs.

In order to reduce the flicker in LCDs, line or column inversion was used, i.e. the polarity of the driving pulses at even line/columns is turned to opposite to that at odd line/columns or to zero. In this way, the positive effect at even columns is compensated by the negative effect at the odd the columns. When this simple line or column inversion method is applied to an electrophoretic display device, the flicker is indeed reduced. A preferred method to implement this inversion is to use identical driving waveforms for both even and odd columns of the display but to start addressing the odd columns with a delay of at least one frame time compared to the even columns. This method is disclosed in a prior, non-pre-published co-pending application EP 0310148.0, filed May 22, 2003 (Applicants'number PHNL030560).

While these inversion approaches, in particular, greatly improve the visual performance of the electronic ink display, they result in a requirement for twice as many reference waveforms to be stored the look-up-tables as in the prior art situations. This additional memory adds to this common problem with these devices: conventional electronic ink display devices typically require large processing circuits for generating data pulses of a new frame, storage of several previous frames and a large look-up table. As different driving waveforms are required at different temperatures the look-up-tables can become rather large. Reducing the size of the memory required for the tables is advantageous.

It is an object of the invention to provide a display in which memory requirements for storing the waveforms used for image updates in the look-up-table of an electrophoretic display device are reduced by ordering the table so that significant portions of the waveforms are reused for different portions of the screen. This capability is especially useful when starting addressing the odd columns with the same waveform, but with a delay of at least one frame time compared to the even columns. Nevertheless, the invention may be implemented in any bi-stable display in which any portions of the screen are addressed with a time delay compared to other parts.

Further advantageous embodiments of the present invention are related below and set forth in the dependent claims.

These and other aspects of the invention will be apparent from and elucidated with reference to the embodiment(s) described hereinafter.

In the drawings:

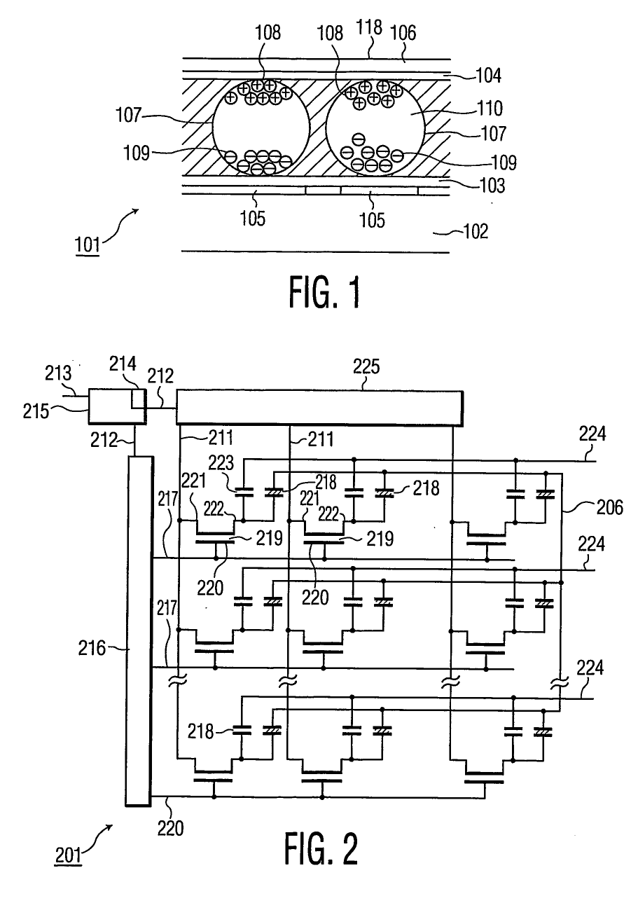

FIG. 1 is a diagrammatic cross-section of a portion of a display device.

FIG. 2 is an equivalent circuit diagram of a portion of a display device.

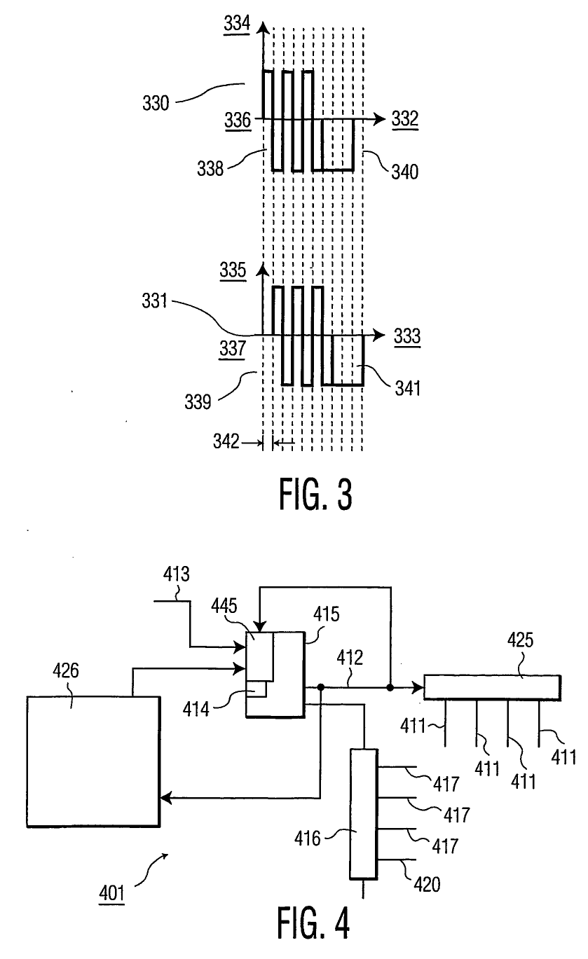

FIG. 3 shows exemplary line inversion waveforms.

FIG. 4 is a schematic of a display device with a memory.

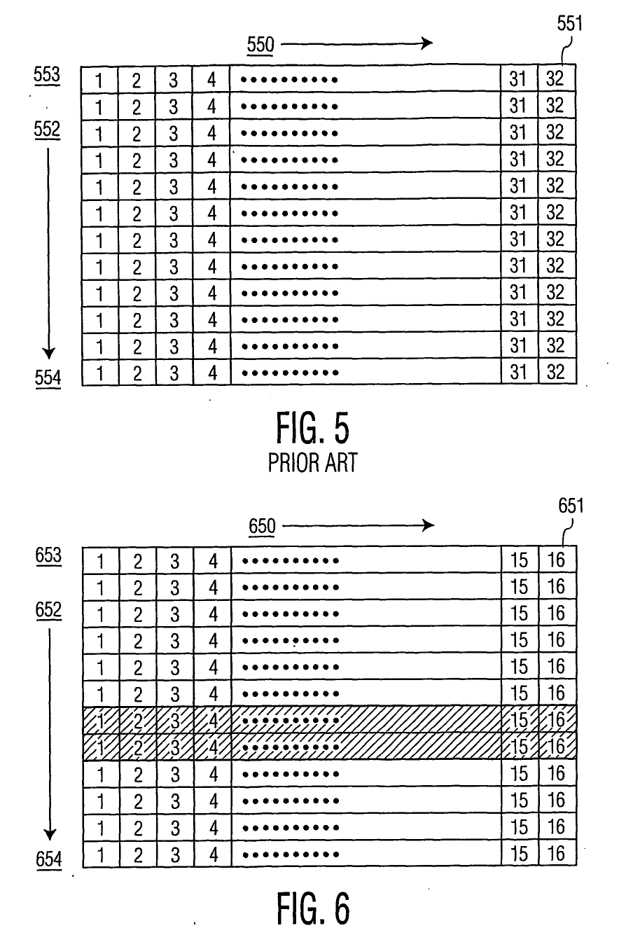

FIG. 5 shows a format of a look-up-table according to the prior art.

FIG. 6 shows a format of a look-up table in accordance with an embodiment of the invention.

The Figures are schematic and not drawn to scale, and, in general, like reference numerals refer to like parts.

FIG. 1 is a diagrammatic cross-section of a portion of an electrophoretic display device 101, for example of the size of a few display elements 118, comprising a base substrate 102, an electrophoretic film with an electronic ink which is present between two transparent substrates 103, 104 of, for example, polyethylene. One of the substrates 103 is provided with transparent pixel electrodes 105 and the other substrate 104 is provided with a transparent counter electrode 106. The electronic ink comprises multiple microcapsules 107 of about 10 to 50 microns. Each microcapsule 107 comprises positively charged white particles 108 and negatively charged black particles 109 suspended in a fluid 110. When a negative field is applied to the counter electrode 106, the white particles 108 move to the side of the microcapsule 107 directed to the counter electrode 106, and the display element 118, here comprising the counter electrode 106, pixel electrode 105 and microcapsule 107, becomes visible to a viewer. Simultaneously, the black particles 109 move to the opposite side of the microcapsule 107 where they are hidden from the viewer. By applying a positive field to the counter electrodes 106, the black particles 109 move to the side of the microcapsule 107 directed to the counter electrode 106, and the display element appears dark to a viewer (not shown). When the electric field is removed, the particles 107 remain in the acquired state and the display exhibits a bi-stable character and consumes substantially no power.

FIG. 2 is an equivalent circuit diagram of a picture display device 201 comprising an electrophoretic film laminated on a base substrate 202 provided with active switching elements, a row driver 216 and a column driver 225. Preferably, a counter electrode 206 is provided on the film comprising the encapsulated electrophoretic ink, but could be alternatively provided on a base substrate in the case of operation with in-plane electric fields. The display device 201 is driven by active switching elements, in this example thin-film transistors 219. It comprises a matrix of display elements at the area of crossings of row or selection electrodes 217 and column or data electrodes 211. The row driver 216 consecutively selects the row electrodes 217, while a column driver 225 provides a data signal to the column electrode 211. Preferably, a controller 215 first processes incoming data 213 into the data signals. The controller 215 includes an intermediate memory 214 which may be register of the CPU of the controller 215. Mutual synchronizations between the column driver 225 and the row driver 216 takes place via drive lines 212. Select signals from the row driver 216 select the pixel electrodes 222 via the thin-film transistors 219 whose gate electrodes 220 are electrically connected to the row electrodes 217 and the source electrodes 221 are electrically connected to the column electrodes 211. A data signal present at the column electrode 211 is transferred to the pixel electrode 222 of the display element coupled to the drain electrode via the TFT. In the embodiment, the display device of FIG.1 also comprises an additional capacitor 223 at the location of each display element 218. In this embodiment, the additional capacitor 223 is connected to one or more storage capacitor lines 224. Instead of TFTs, other switching elements can be used, such as diodes, MIMs, etc.

FIG. 3 shows example waveforms 330,331 in which a series of opposite voltage pulses is applied to even 336 and odd columns 337, using column inversion. The horizontal direction 332, 333 is time. The vertical direction 334, 335 is the amplitude of the potential difference applied to the display element. Here, the voltage pulses of the waveforms 330, 331 are made up of preset 338, 339 and drive signals 340, 341. In this example the waveform starts with positive sign at even columns 336 and at negative sign at odd columns 337 and the waveforms of the odd columns 337 are delayed by a frame period T_{F} 342.

FIG. 4 shows a conventional electrophoretic display device 401 for displaying image information provided to the display device in a series of consecutive frames N−1, N, N+1. The display device has a similar arrangement as the device as shown in FIG. 2, extended with memory means, for example, a RAM memory 426 for storing, for example, a current state of the display elements corresponding to the current frame N which is being displayed and an intermediate memory 414, typically a RAM of limited size and high speed. Furthermore, controller 415 is arranged to generate the drive signal 412 in dependence upon the stored current state of the display element corresponding to the current frame N being displayed and the new state of the display element corresponding to the new frame N+1 to be displayed. The drive signal 412 is applied to the column driver 425.

The controller 415 comprises a look-up table 445 which has address entries corresponding to the current state of the display element and the new state of the display element. The look-up table entry then consists of 16 waveforms. These entries of the look-up table 445 point to predetermined parameters of the waveform for transition of a display element from, for example, a first gray value which is one of four grayscale values, corresponding to a current state corresponding to frame N to a second gray value, which is also one of the four grayscale values, in a new state corresponding to frame N+1.

The look-up table 445 can be realized in a ROM memory and can be external to the controller 415. The drive signal may consist of a pulse of fixed duration and varying amplitude, a pulse with a fixed amplitude, alternating polarity and a varying duration between two extreme values, and a hybrid drive signal wherein both the pulse length and the amplitude can be varied. For a pulse amplitude drive signal, this predetermined drive parameter indicates the amplitude of the drive signal including the sign thereof. For a pulse time modulated drive signal, the predetermined drive parameter indicates the duration and sign of the pulse making up the drive signal. For a hybrid generation or pulse-shaped drive signal, the predetermined drive parameter indicates the amplitude and the length of portions making up the drive pulse. The predetermined drive parameter may be, for example, an 8-bit number. For each entry in the look-up table 445, the drive parameter is experimentally determined for a selected type of electronic ink for a corresponding gray level transition and different predetermined operating temperatures.

FIG. 5 illustrates the format of a look-up table according to the prior art. In FIG. 5 the horizontal direction 550 indicates an address number 551 for each of the alternative waveforms (e.g. 330 in FIG. 3) that may be addressed to a pixel of the display. The vertical direction 552 is the frame number. Time delay is external. The frames are shown scanned from the top 553 to the bottom 554 of FIG. 5. The look-up-table of FIG. 5 is for a display operating with four gray levels. In this case, there are 16 waveforms required to change pixels from any one of the four previous gray levels to any new gray level. In the situation where, for example, column inversion is used for any of the reasons discussed above, a further 16 driving waveforms are required for the second set of columns. This results, as indicated by the address numbers 551 in FIG. 5, in a requirement for a memory with 32 addresses for every frame period of the waveform. The first 16 addresses in a row of FIG. 5 may, for example, be for the even numbered columns, and the last 16 for the odd numbered. The addresses contain the voltage required for each waveform for every frame period of the reset—for example either a positive, a negative or a zero voltage if a pulse width modulation scheme is being used, or a variable voltage if a voltage modulated driver is available.

FIG. 6 represents a look-up-table constructed in accordance with an embodiment of the present invention, in the situation where, for example, the column inversion of delayed, but otherwise identical, drive waveforms shown in FIG. 3 are used.

The reference numbers of FIG. 6 refer to the same parts of the figure as the corresponding numbers in FIG. 5. The horizontal direction 650 in FIG. 6 indicates an address number 651 for each of the alternative waveforms that may be addressed to a pixel of the display. The vertical direction 652 is the frame number. Time delay is external. The frames are shown scanned from the top 653 to the bottom 654 of FIG. 5.

The table now consists of only half of the number of addresses as the prior art situation (16 in this case of a 4 gray level display) of FIG. 6.

In operation of the display:

The first line of the look-up table is read into a small intermediate memory, for example reference number 414 of FIG. 4.

Pixels in the first portion of the display (for example, the even numbered columns) read the data from the top line (the first frame number) from the intermediate memory 414.

The controller 415 reads the look-up table for at least the first and second frame (for a delay of 1 frame). This data is held in the intermediate memory 414 (which contains, for this, 2×16×2=64 bits).

Pixels in the first portion of the display (the even numbered columns) will now read the data from the second line (the second frame number) from the intermediate memory 414, while pixels in the second portion of the display (the odd numbered columns) will read the data from the top line (the first frame number) from the intermediate memory 414.

In the next step, the second and third frame data are stored in the second intermediate memory, and the process continues.

In this way, a required column inversion is realized, while a smaller look-up-table results. More frames will be read into the memory if a longer delay is required.

In further embodiments, a plurality of time delays could be defined by the controller 415, whereby further portions of the display may be delayed by different periods. In this case also more frames will be read into the memory if a variable delay is required.

Finally, the above-discussion is intended to be merely illustrative of the present invention and should not be construed as limiting the appended claims to any particular embodiment or group of embodiments. For example, the controller 415 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the systems utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference numerals in the claims are for illustration purposes only and do not limit their protective scope;
d) several “means” may be represented by the same item or hardware or software implemented structure or function; and

each of the disclosed elements may be comprised of hardware portions (e.g., discrete electronic circuitry), software portions (e.g., computer programming), or any combination thereof.

1. A display device (101) comprising:
electrophoretic particles (108, 109);
a display element (118) and a next display element, each comprising a pixel electrode (222) and an associated counter electrode (206), between which a portion of the electrophoretic particles (108, 109) is present;
a controller (215), the controller (215) being configured to determine a desired waveform (340) to be applied to the display element pixel electrode (222) and the display element counter electrode (206) to bring the display element (118) to a predetermined optical state corresponding to incoming data (213) to be displayed,
the controller (215) being further configured to determine a desired next waveform (341) to be applied to the next display element pixel electrode (222) and the next display element counter electrode (206) to bring the next display element to a predetermined next optical state corresponding to incoming data (213) to be displayed;
a memory storing a look-up table containing one or more reference waveforms; and
an intermediate memory (414),
one of the one or more reference waveforms and a next one of the one or more reference waveforms being received and stored by the intermediate memory (414) in consecutive frames, the intermediate memory (414) storing a frame N comprising a portion of the one of the one or more reference waveforms accessible by the controller (215) before a next frame N+1 comprising all or a next portion of the next one of the one or more reference waveforms,
the controller (215) being further arranged to generate the desired next waveform (341) in dependence upon the desired waveform (340).

2. The display device (101) of claim 1 wherein the controller (415) generates the desired next waveform (341) to effect a line inversion.

3. The display device (101) of claim 1 wherein the controller (415) generates the desired next waveform (341) to effect a column inversion.

4. The display device (101) of claim 1 wherein the controller (415) generates the desired next waveform (341) by varying the order in which frames of the desired waveform (340) and the desired next waveform (341) are read from the intermediate memory (414) and addressed to the display element (118) and next display element.

5. The display device (101) of claim 1 wherein the controller sets a plurality of time delays between the desired waveform (340) and the next one of the one or more reference waveforms to form additional frames readable from the intermediate memory (414) to generate the desired next waveform (341).

6. The display device (101) of claim 1 wherein the intermediate memory (414) is a random access memory of limited size and high speed.

7. The display device (101) of claim 6 wherein the intermediate memory (414) is a register of the CPU of the controller (415).

8. The display device (101) of claim 1 wherein portions of a screen of the display device (101) are addressed with a time delay with respect to other portions of the display.

9. The display device (101) of claim 1 wherein the predetermined optical state is a grayscale.

10. The display device (101) of claim 1 wherein the predetermined optical state is a color.

11. A display device (101) comprising:
electrophoretic particles (108, 109);
a display element (118) comprising a pixel electrode (222) and an associated counter electrode (206), between which a portion of the electrophoretic particles (108, 109) is present;
a controller (215) configured to determine a desired waveform (340) to be applied to the pixel electrode (222) and the counter electrode (206) to bring the display element (118) to a predetermined optical state corresponding to incoming data (213) to be displayed; and
a memory storing a look-up table containing one or more reference waveforms,
the controller (215) being further arranged to incorporate a portion of one of the one or more reference waveforms and a further one of the reference waveforms to determine the desired waveform (340).

12. The display device (101) of claim 11 wherein the controller (215) reads the portion of one of the one or more reference waveforms from a second desired waveform capable of being applied to a second display element of the display device (101).

13. A computer program product for displaying information on a display (101) having display elements (118) arranged in a plurality of rows and columns, the computer program product comprising computer code devices configured to cause a computer to change one or more of the display elements (118) from a first state to a second state by application of a waveform, said waveform being determined by incorporating a part of a reference waveform and a further reference waveform.

14. The computer program product of claim 13 wherein the part of the reference waveform incorporated is a time delay.

15. The computer program product of claim 13 wherein the waveform differs from a preceding waveform by a time delay.

16. The computer program product of claim 13 wherein at least a frame of the portion of a reference waveform and at least a frame of the further reference waveform are stored in an intermediate memory (414) of the computer.

17. A method for displaying information on a display element (118) of a display device (101) comprising:
storing a look-up table containing data representing a reference waveform necessary to bring the display element (118) to one or more states;
retrieving at least a portion of the data representing the reference waveform corresponding to a desired state of the display element (118) and storing the at least a portion of the data representing the reference waveform in an intermediate memory (414);
storing in the intermediate memory (414) a portion of data representing a second reference waveform necessary to bring the display element (118) to the desired state; and
inserting the portion of data representing a second reference waveform in the at least a portion of the data representing the reference waveform corresponding to the desired state of the display element (118) to form a desired waveform, the desired waveform being capable of being applied to the display element (118) to bring the display element (118) to the desired state.

18. The method of claim 17 wherein the portion of data representing a second reference waveform comprises a time delay frame.

19. The method of claim 17 wherein the reference waveform and the second reference waveform are the same waveform.

20. A method for displaying information on display elements (118) of a display device (101) comprising:
storing a look-up table containing data representing a reference waveform necessary to bring the display elements (118) to one or more states;
retrieving at least a portion of the data, the portion representing a first reference waveform corresponding to a desired state of a first of the display elements (118) and storing the at least a portion of the data representing the first reference waveform in an intermediate memory (414);
retrieving at least a portion of data representing a second reference waveform corresponding to a desired state of a second of the display elements (118) and storing the at least a portion of the data representing the second reference waveform in the intermediate memory (414); and
reading a first frame of the at least a portion of the data representing the first reference waveform to generate a first desired waveform; and then reading a first frame of the at least a portion of the data representing the first reference waveform in sequence with a subsequent frame of the at least a portion of the data representing the second reference waveform to generate a second desired waveform, the second desired waveform being capable of being applied to the second display element to bring the second display element to the desired state of the second of the display elements (118).
